(19) United States
(12) Patent Application Publication
(10) Pub. No.: US 2008/0223219 A1
(43) Pub. Date: Sep. 18, 2008

(54) Coffee Machine and Holder for Receiving a Coffee Pad

(75) Inventors: Johann Magg, St. Georgen (DE); Andreas Mayr, Breitbrunn am Chiemsee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/586,624

(22) PCT Filed: Jan. 24, 2005
(86) PCT No.: PCT/EP2005/050279

§ 371 Date: Jul. 19, 2006

(30) Foreign Application Priority Data
Jan. 30, 2004 (DE) 10 2004 004 836.3

(51) Int. Cl. A47J 31/06

(52) U.S. Cl. 99/295

(57) ABSTRACT

A coffee machine comprising a holder for receiving a coffee pad. The holder is provided with an opening for inserting a coffee, and at least one outlet, a carrier for receiving the holder and a holder cover which can cooperate with a sealing surface of the holder, such that a pressure chamber surrounding an inserted coffee pad can be formed. In order to reduce the production costs of the coffee machine and to maintain and/or improve operability, the holder is embodied as a single part.

The invention relates to a coffee machine and a holder for receiving a coffee pad.

Coffee machines in the prior art operate according to different principles. The most common models are the so-called pressureless coffee machines. In these water flows from a storage container into an electrically heatable pipe. Particularly as a result of the evolution of steam in this pipe, heated water is then pushed through a riser to an outlet via which the heated water then drips into a coffee filter. The filter coffee can then flow from this coffee filter at atmospheric pressure into a pot.

In contrast, in espresso machines an elevated pressure prevails in the area of the coffee grounds, for example 15 bar. This is achieved by supplying water from a water container or another water supply to an electric-motor-driven pump which then supplies the water at high pressure via an electrically heatable area to a coffee grounds receiving device. This coffee grounds receiving device generally comprises a filter for receiving the coffee. In order to generate the high pressure in the coffee area, during operation the coffee grounds receiving device is located in an area which is sealed towards the atmosphere, which can be designated as a pressure chamber or brewing chamber.

In another coffee machine which operates on a different principle, it is provided to first transfer the water for preparing the coffee from a water container into a heatable intermediate container. From this intermediate chamber the heated water is passed to an electric-motor-driven pump from which it is supplied at elevated pressure, for example 2 to 3 bar, to a coffee grounds receiving device. In this case, it is provided that unlike in the espresso machine the coffee is not introduced into the coffee grounds receiving device as coffee grounds but is inserted in a holder in the form of a coffee pad, that is, in compacted form surrounded by filter paper. The holder with a holder cover via which water is supplied can form a sealed pressure chamber. At the same time, the holder for the coffee pads is allocated a plurality of functions. Firstly, the holders provides a sealing surface so that a pressure chamber can be formed. Moreover, the holder has an outlet opening from which the coffee can emerge. Furthermore, the coffee pad should be mounted in the holder in a manner such that flow through the coffee pad is not impeded. Such a coffee machine occupies an intermediate position between a conventional pressureless coffee machine and an espresso machine.

Coffee pad holders in the prior art are constructed flexibly with regard to the various functions. For example, the base body of the holder is stamped from sheet metal, a bearing area of the holder is made of plastic and provided with spacers and the coffee outlet opening is achieved by a hole in a ceramic insert. Furthermore, a handle is attached to the base body made of metal, the handle being made of plastic for reasons of heat insulation. In order to ensure a defined path for the coffee through the multi-component holder, a seal is provided between the base body and the plastic bearing area,

It is the object of the invention to provide a holder for coffee pads which has a simple structure, which is in no way inferior to the holders of the prior art in terms of its operating mode or is superior thereto and which can be produced cost-effectively.

This object is achieved with the features of the independent claims.

Advantageous embodiments of the invention are given in the dependent claims.

The invention builds on the generic coffee machine in that the holder is constructed in one piece. Such a one-piece holder can be constructed particularly cost-effectively. Furthermore, no sealing means are required between components of different materials to define a unique path for the water or the coffee. The functionality of the holder is thus ensured. This applies particularly after a long operating time since no internal sealing components are provided and these cannot wear or age in this respect. The pressure chamber formed by the holder and the holder cover forms the brewing chamber during operation of the washing machine. In this case, the holder cover is preferably made of an elastic material, for example, silicone so that so that the pressure chamber can be reliably sealed by pressing together the holder with the holder cover.

It is particularly advantageous if the holder is made of a thermoplastic material by means of injection moulding. This is a particularly cost-effective variant. Various materials can be used, for example, polypropylene, and numerous creative possibilities are provided with regard to the shaping of the holder.

It is usefully provided that the holder has a handle constructed in one piece with the holder. By means of this handle, the holder can be removed from the coffee machine to remove a used coffee pad. The holder can then be re-inserted in the coffee machine, and in particular a new coffee pad can be inserted. Since the handle is fabricated in one piece with the holder, this can be moulded-on at the same time during the injection moulding so that, apart from the material used for the handle, no additional costs are incurred for the provision of such a handle.

The invention is further developed in a particularly advantageous fashion in that the outlet opening is circular and has a diameter of about 0.5 to 1.5 mm. These outlet openings are suitable on the one hand for ensuring that sufficient pressure builds up in the pressure chamber but on the other hand can allow a sufficient quantity of coffee to leave the pressure chamber. In particular, at diameters in the range of 1 mm, a coffee having a pleasantly tasting froth is prepared similar to the conventional espresso. As a result of the injection moulding technique used to produce the holder, differently shaped outlet openings are also feasible, which can for example have elliptical or polygonal cross-sections.

The effect with regard to the froth is further assisted by the outlet opening being expanded in a funnel shape in the outlet direction. As a result of this funnel-shaped expansion, an increased flow velocity of the emerging coffee is achieved on the basis of fluid-mechanical principles so that this can advantageously mix with air to form froth.

It is preferably provided that the outlet opening is arranged at the lowest point of the pressure chamber. In this way, it is particularly avoided that any residue remains in the pressure chamber.

The invention is usefully further developed in that the carrier has a bearing area for the coffee pad which is provided with a plurality of spacers so that a free space is provided between the bearing area and the coffee pad. This promotes the flow of hot water through the coffee pad wherein it should be particularly emphasised with regard to the invention that these spacers can simply be formed by injection moulding.

The invention further relates to a one-piece holder for use in a coffee machine according to the invention.

The invention is based on the finding that generic coffee machines can be fabricated in a cost-effective manner by using a holder for coffee pads which is formed in one piece and the simplified fabrication does not involve any deterioration with regard to the functioning capability of the coffee machine. In contrast, longer lifetimes can be achieved compared with holders of the prior art since the number of seals required in the coffee machine is reduced.

The invention is now explained in detail with reference to the accompanying drawings using particularly preferred embodiments. In the figures:

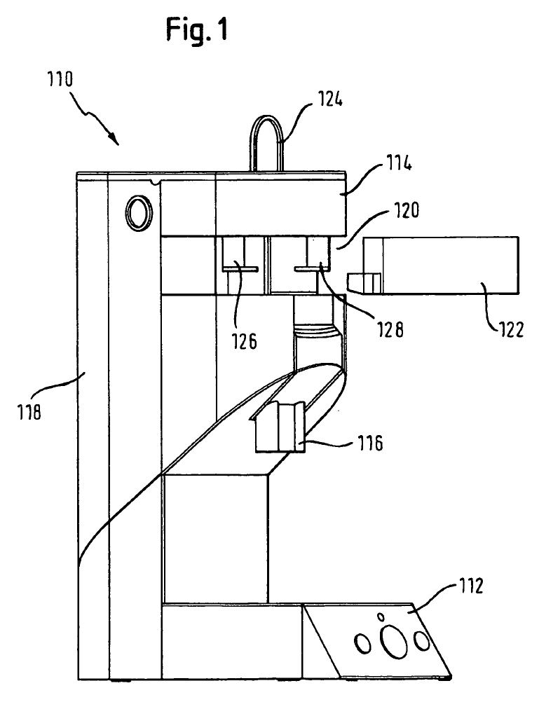

FIG. 1 is a perspective view of a coffee machine to explain the invention;

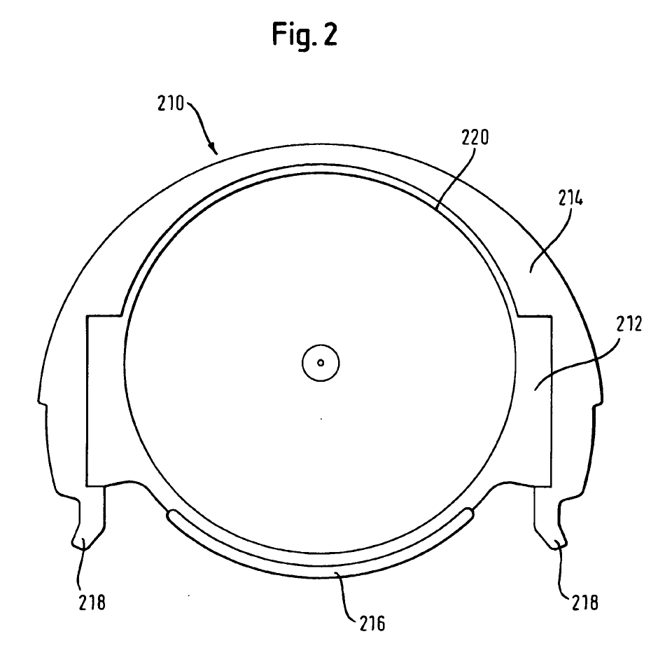

FIG. 2 is a plan view of a holder according to the invention inserted in a carrier;

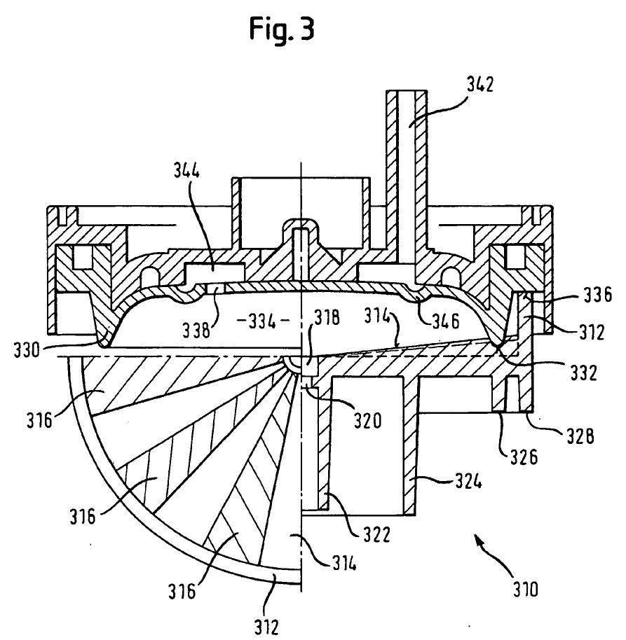

FIG. 3 is a diagram of a brewing chamber and associated components, partly in sectional view and partly in plan view;

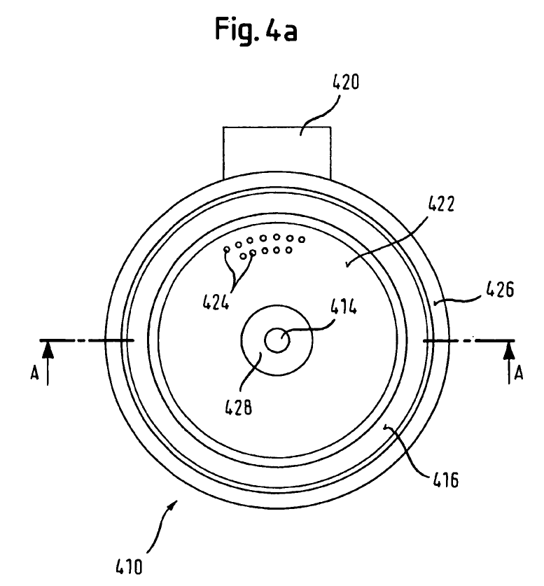

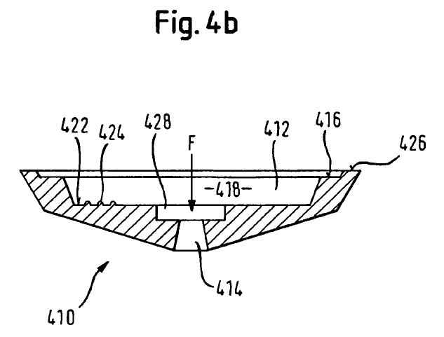

FIG. 4a is a plan view of a coffee pad holder according to the invention; and

FIG. 4b is a sectional view along the line marked AA in FIG. 4a through a coffee pad holder according to the invention.

FIG. 1 shows a perspective view of a coffee machine to explain the invention. The coffee machine 110 according to the invention comprises a flat front portion 112 and a columnar rear assembly 114. Cups for removing coffee via an outlet 116 can be arranged on the front portion 112. A water container 118 is inserted in the rear assembly 114. The rear assembly 114 further comprises a slide-in area 120 into which a drawer 122 with a coffee pad holder inserted therein can be slid, this being described in further detail in connection with FIG. 2. The drawer 122 is shown here in the removed state. Located above the slide-in area 120 inside the housing are a water supply and a holder cover which together with the holder sitting in the drawer 122 form the brewing chamber. This is sealed after inserting the drawer 122 by shifting the lever 124 and lifting the clamps 126, 128 hereby effected by pressing together the holder and holder cover.

FIG. 2 shows a plan view of a holder according to the invention inserted in a carrier. The carrier embodied as a drawer 210 has a base area 212 and an elevated edge are 214, 216. Guide continuations 218 are further provided to facilitate the insertion of the drawer 210 in the slide-in area 120 (see FIG. 1). The coffee pad holder 220 is inserted in the drawer 210. Possible embodiments of this coffee pad holder 220 are explained as an example with reference to the other figures.

FIG. 3 shows a diagram of a brewing chamber and associated components, partly in sectional view and partly in plan view. The lower left quadrant of FIG. 3 shows a plan view of a holder 310 according to the invention. The holder 310 has an edge 312 and a base area 314. The base area is divided into a plurality of segments wherein elevated segments 316 are shown hatched. As can be seen in the right-hand part of FIG. 3, the base area 314 is constructed as inclined towards the centre of the holder 310 as a whole. The angle of inclination of the elevated segments 316 is 5.5 degrees for example, whilst the remainder of the base area 314 has an angle of inclination of 5 degrees. Provided at the centre of the holder 310 is a recess 318 which is adjoined at the bottom by an outlet opening 320 for the coffee. The holder 310 is furthermore equipped with cylindrically extending continuations by which means it is centred in the drawer 210 (see FIG. 2). An elastic holder cover 330, preferably made of silicone, is located opposite to the one-piece holder which is preferably made of hard plastic. At a first sealing surface 332, this holder cover 330 seals a pressure chamber 334 acting as a brewing chamber from the outside area. A second sealing surface 336 is provided at the edge 312 of the holder 310, this being located further radially outwards. The holder cover 330 is provided with a plurality of openings 338 which are distributed preferably uniformly along a circumference. For example, five openings are provided. The holder cover 330 is preferably fixed on a carrier preferably made of hard plastic, for example, by means of a screw (not shown) located at the centre. This carrier has a water supply 342 via which water enters into a channel 344 extending along a circumference. Starting from this channel 344, the water can then enter into the brewing chamber 334 via the openings 338. Projecting regions 346 are furthermore provided on the holder cover, these being implemented as a bead extending along a circumference in the present exemplary embodiment. It is also possible to provide a plurality of individual projecting regions. These serve to press a coffee pad arranged in the brewing chamber 334 against the holder 310 and thereby secure it.

The holder cover 330 is arranged fixedly in the coffee machine together with the component containing the water supply 342. The holder 310 can be removed from the slide-in area 120 (see FIG. 1) together with the drawer 210 (see FIG. 2). For this purpose, the drawer 210 and together with this the holder 310 is lowered downwards by a lever mechanism so that there is no further contact at the sealing surfaces 332, 336. The drawer can then be removed, a new coffee pad can be inserted in the holder 310 and the drawer 210 can then be re-inserted into the slide-in area 320. By actuating the lever mechanism, the drawer 210 together with the holder 310 is raised again so that the pressure chamber 334 is sealed.

FIG. 4a shows a plan view of a coffee pad holder according to the invention. FIG. 4b shows a sectional view along the line marked AA in FIG. 2 through a coffee pad holder according to the invention. The holder 410 constructed in one piece has a substantially cylindrically symmetrical structure where a laterally protruding handle 420 is additionally provided. The holder 410 has an opening 412 for inserting a coffee pad (not shown) and a centrally located outlet opening 414. In order to be able to build up a pressure in a pressure chamber 418 in the area of the coffee pad, a circumferential sealing surface 416 is provided which can cooperate with sealing means (not shown) of a holder cover. A circumferential elevations 426 is constructed radially outwards for better sealing. The bearing area 422 for the coffee pad is located radially inside the sealing surface 416. A plurality of spacers 424 are moulded thereon, of which only a few are shown as an example. The spacers 424 are preferably distributed uniformly over the bearing surface 422. A recess 428 surrounding an outlet opening 414 is provided radially inside the bearing area 422. This outlet opening 414 is expanded in a funnel shape in the direction of flow indicated by the arrow F.

The individual features of the embodiments shown in FIG. 3 and FIGS. 4a, 4b can be combined with one another in numerous ways. For example, it is possible to modify the embodiments from FIG. 3 such that elevated segments 316 are provided but the base area 314 is configured without any slope as in the holder according to FIGS. 4a, 4b. Conversely it is possible to configure the base area of the coffee pad holder as inwardly sloping as shown in FIGS. 4a, 4b. The various variants with regard to the outlet opening 320, 414 can also be implemented in both embodiments.

The features of the invention disclosed in the preceding description, in the drawings and in the claims can be important for carrying out the invention both individually and also in any combination.

### REFERENCE LIST

110 Coffee machine

112 Front portion

114 Rear assembly

116 Outlet

118 Water container

120 Slide-in area

122 Drawer

124 Lever

126 Clamp

128 Clamp

210 Drawer

212 Base area

214 Edge area

216 Edge area

218 Guide continuations

220 Coffee pad holder

310 Coffee pad holder

312 Edge

314 Base area, bearing area

316 Elevated segment

318 Recess

320 Outlet opening

330 Holder cover

332 First sealing surface

334 Pressure chamber, brewing chamber

336 Second sealing area

338 Opening

342 Water supply

344 Channel

346 Projecting area

410 coffee pad holder

412 Opening

414 Outlet opening

416 Circumferential sealing surface

418 Pressure chamber, brewing chamber

420 Handle

422 Bearing area

424 Spacer

426 Elevation

428 Recess

1-8. (canceled)

9. A coffee machine comprising a holder for receiving a coffee pad for insertion in a brewing chamber, said holder being provided with an outlet opening for coffee and a carrier base forming drain channels, wherein the holder is constructed in one piece with the carrier base.

10. The coffee machine according to claim 9, wherein the one-piece holder is made from a thermoplastic material.

11. The coffee machine according to claim 9, wherein the one-piece holder has a handle.

12. The coffee machine according to claim 9, wherein the outlet opening is provided in the one-piece holder and has a minimum diameter of about 0.5 to 1.5 mm.

13. The coffee machine according to claim 12, wherein the outlet opening is expanded in a funnel shape in the outlet direction.

14. The coffee machine according to claim 13, wherein the outlet opening is located at the lowest point of the pressure chamber.

15. The coffee machine according to claim 9, wherein the carrier base has a bearing area for the coffee pad which is provided with a number of spacing segments so that drain channels for the coffee are formed between respective segments.
